(19) United States
(12) Patent Application Publication
(10) Pub. No.: US 2024/0276417 A1
(43) Pub. Date: Aug. 15, 2024

(54) INFORMATION PROCESSING APPARATUS, COMMUNICATION APPARATUS, CONTROL METHOD, AND COMPUTER-READABLE STORAGE MEDIUM

(71) Applicant: CANON KABUSHIKI KAISHA, Tokyo (JP)

(72) Inventor: Tetsuya Katsuragi, Tokyo (JP)

(21) Appl. No.: 18/644,568

(22) Filed: Apr. 24, 2024

Related U.S. Application Data
(63) Continuation of application No. PCT/JP2022/040366, filed on Oct. 28, 2022.

(30) Foreign Application Priority Data
Dec. 3, 2021 (JP) 2021-197280

(51) Int. Cl. H04W 60/04; H04L 67/55; H04W 92/18

(52) U.S. Cl. CPC H04W 60/04; H04L 67/55; H04W 92/18

(57) ABSTRACT

An information processing apparatus registers a communication apparatus that has requested to distribute information and a communication apparatus that has requested to receive the distributed information in association with identification information for identifying a topic of the distribution, and stores, in association with the identification information, a parameter for direct communication between a plurality of communication apparatuses. This information processing apparatus provides a first parameter stored in association with first identification information to a first communication apparatus that has requested to distribute information of a first topic corresponding to the first identification information and a second communication apparatus that has requested to receive the information of the first topic corresponding to the first identification information.

### CROSS-REFERENCE TO RELATED APPLICATIONS

This application is a Continuation of International Patent Application No. PCT/JP2022/040366, filed Oct. 28, 2022, which claims the benefit of Japanese Patent Application No. 2021-197280 filed Dec. 3, 2021, both of which are hereby incorporated by reference herein in their entirety.

### BACKGROUND OF THE INVENTION

### Field of the Invention

The present invention relates to setting processing for direct communication.

### Background Art

As a method of communication between terminals, there is known a publish/subscribe communication method of enabling asynchronous communication between a terminal operating as a publisher for distributing information and a terminal operating as a subscriber for receiving the information (see Japanese Patent Laid-Open No. 2017-027499). In this communication method, the publisher registers, as a topic, a message to be transmitted, and the subscriber requests distribution of a topic corresponding to information to be acquired by the self-apparatus. Then, the topic registered by the publisher is distributed to the subscriber that has requested distribution of the topic. By using this communication method, the publisher and the subscriber can communicate with each other without being conscious of the partner apparatus. This can ensure scalability of a communication system and readily implement communication processing in each terminal. This publish/subscribe communication method can be applied to communication between terminals of moving bodies.

On the other hand, in the publish/subscribe communication method, it is necessary to execute a predetermined procedure of registering a topic and distributing information to the subscriber, and thus this method is not always suitable to immediate communication. Furthermore, for example, a terminal complying with a 3rd Generation Partnership Project (3GPP) cellular communication standard such as Long Term Evolution (LTE) or 5th Generation (5G) generally communicates with another terminal via a network of a cellular communication system. In this way, a terminal of a cellular communication system communicates with another terminal via a base station and other nodes, thereby requiring a predetermined time for communication itself.

On the other hand, the cellular communication standard such as LTE or 5G defines not only communication between a base station and a terminal but also the specification concerning direct communication called sidelink communication that is executed by a terminal with another terminal existing within a short-distance range. A layer 2 identifier (L2ID) is used for sidelink communication, and the terminal generates a frame by designating, as a destination, the L2ID of another apparatus with which direction communication is to be performed, and transmits the frame. The terminal can receive a frame including the L2ID of the self-apparatus as a destination from another terminal, and acquire data. Note that “layer 2” indicates layer 2 of the 3GPP protocol stack. Japanese Patent Laid-Open No. 2020-188405 describes a technique of efficiently performing sidelink communication between terminals mounted in vehicles in accordance with the positions of the terminals by associating the positions and L2IDs with each other.

In the technique described in Japanese Patent Laid-Open No. 2020-188405, an L2ID is decided in accordance with a position, and a partner with which sidelink communication can be performed is specified. Therefore, a terminal indiscriminately performs sidelink communication with another terminal existing in the vicinity of the self-apparatus, and may be unable to communicate with an appropriate partner apparatus with which sidelink communication is to be performed.

### SUMMARY OF THE INVENTION

The present invention provides a technique in which a wireless terminal performs high immediacy communication with an appropriate partner apparatus.

An information processing apparatus according to one aspect of the present invention comprises: a registration unit configured to register a communication apparatus that has requested to distribute information and a communication apparatus that has requested to receive the distributed information in association with identification information for identifying a topic of the distribution; a storage unit configured to store, in association with the identification information, a parameter for direct communication between a plurality of communication apparatuses; and a providing unit configured to provide a first parameter stored in association with first identification information to a first communication apparatus that has requested to distribute information of a first topic corresponding to the first identification information and a second communication apparatus that has requested to receive the information of the first topic corresponding to the first identification information.

A communication apparatus according to one aspect of the present invention comprises: a notification unit configured to notify an information processing apparatus of a request to distribute information or receive the distributed information and to register the communication apparatus in association with identification information for identifying a topic of the distribution; a reception unit configured to receive a parameter, associated with the identification information, for direct communication with another apparatus as a response to the request; and a communication unit configured to distribute or receive information of the topic corresponding to the identification information by performing, by using the parameter, direct communication with another communication apparatus that has been registered by the information processing apparatus in association with the identification information and has received the parameter.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a view showing an example of the configuration of a system.

FIG. 2 is a view showing an example of a status in which connection is established by sidelink.

FIG. 3 is a block diagram showing an example of the hardware arrangement of an apparatus.

FIG. 4 is a block diagram showing an example of the functional arrangement of a server.

FIG. 5 is a table showing an example of information for associating a topic and an L2ID with each other.

FIG. 6 is a block diagram showing an example of the functional arrangement of a wireless communication apparatus.

FIG. 7 is a sequence chart showing an example of the procedure of L2ID sharing processing.

FIG. 8 is a flowchart illustrating an example of the procedure of processing executed by the server.

FIG. 9 is a flowchart illustrating an example of the procedure of processing executed by the wireless communication apparatus.

FIG. 10 is a sequence chart showing an example of connection by sidelink broadcast/groupcast.

FIG. 11 is a sequence chart showing an example of connection by sidelink unicast.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### (Configuration of System)

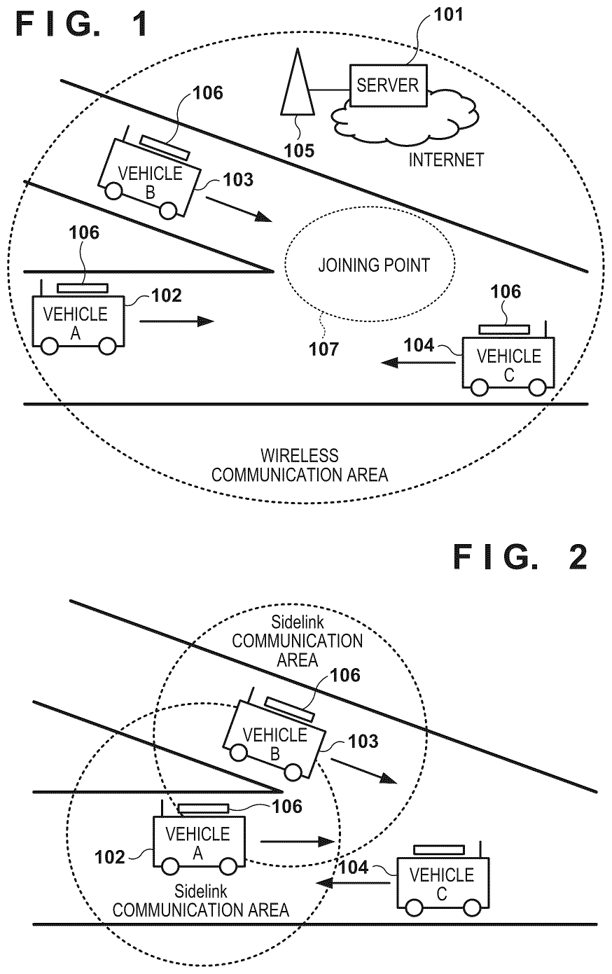

FIG. 1 shows an example of the configuration of a system according to this embodiment. This system is a wireless communication system that enables communication between vehicles. Each of vehicles 102 to 104 includes an in-vehicle wireless communication apparatus 106. The wireless communication apparatus 106 can be, for example, a wireless communication apparatus complying with a 3rd Generation Partnership Project (3GPP) cellular communication standard. Note that the cellular communication standard is, for example, the Long Term Evolution (LTE) standard or 5th Generation (5G) standard, and the wireless communication apparatus 106 is configured to be able to communicate with a base station 105 in compliance with the standard. The wireless communication apparatus 106 can communicate with an information processing apparatus (server 101) arranged on, for example, the Internet or cloud via the base station 105.

In this embodiment, the wireless communication apparatus 106 is configured to be able to communicate with another wireless communication apparatus 106 by executing publish/subscribe communication using a cellular communication system. That is, the wireless communication apparatus 106 mounted in each of the vehicles 102 to 104 has a function of performing communication by functioning as a publisher that registers, as a topic, information to be distributed or as a subscriber that acquires information concerning a predetermined topic. The server 101 operates as a broker of publish/subscribe communication. That is, the server 101 accepts the registration of a topic from the wireless communication apparatus 106, and distributes information associated with the topic. The role of registering a topic and distributing information is called a publisher. In addition, the server 101 accepts a subscription registration request for the registered topic from another wireless communication apparatus 106, and performs registration. The information concerning the topic is distributed to the wireless communication apparatus 106 for which the subscription registration has been performed. The role of sending the subscription registration request and receiving the distributed information is called a subscriber.

If the distance of the wireless communication apparatus 106 to another wireless communication apparatus 106 is sufficiently small, the wireless communication apparatus 106 can perform direct communication with the other wireless communication apparatus 106 by sidelink. For example, as shown in FIG. 2, when the vehicles 102 and 103 move, the wireless communication apparatuses 106 mounted in these vehicles can enter an area of one another where sidelink communication can be performed. At this time, these wireless communication apparatuses 106 can establish sidelink to perform direct communication without intervention of the base station 105.

In this embodiment, assume that each of the vehicles 102 to 104 travels toward a join point 107. When the traveling vehicles 102 to 104 move close to each other at the join point 107 or an intersection with poor visibility, it is useful for the vehicles to notify one another of pieces of information of the self-apparatuses. In this embodiment, the notification of the information is made using the publish/subscribe communication method and sidelink communication. In this embodiment, for example, one of the wireless communication apparatuses 106 mounted in the vehicles traveling toward the join point 107 serves as a publisher to register a topic concerning the join point 107. Then, another wireless communication apparatus 106 is registered as a subscriber for the topic, and acquires information concerning the topic. At this time, for example, a layer 2 identifier (L2ID) as identification information to be used for sidelink communication is assigned to each topic. Then, when the vehicles 102 to 104 move close to each other, they perform sidelink communication using the L2ID. The server 101 serves as a broker to accept registration of the topic concerning the join point 107, accept subscription registration for the topic, and distribute information associated with the topic to the subscriber by the publisher. Furthermore, the server 101 notifies the publisher of the L2ID when registering the topic, and distributes the L2ID to the subscriber that has performed subscription registration for the topic. Thus, when the vehicles 102 to 104 move close to each other, the wireless communication apparatuses 106 mounted in the vehicles can perform direct communication using sidelink.

As described above, one or more wireless communication apparatuses 106 mounted in the vehicles that are scheduled to travel toward the join point 107 perform registration with respect to a common topic by the publish/subscribe communication method. Thus, the one or more wireless communication apparatuses 106 acquire a common L2ID. Note that the wireless communication apparatus 106 operating as a publisher is mounted in, for example, the vehicle, and can distribute information of a traffic condition of a road on which the vehicle is traveling, which is obtained by analysis based on information acquired by an image capturing apparatus, a sensor, or the like connected to the wireless communication apparatus 106. In addition, when the wireless communication apparatuses 106 move close to each other, they can exchange information requiring immediacy by sidelink communication. The information requiring immediacy can include, for example, information such as information requiring immediacy among pieces of information of traffic conditions, and the position, speed, and vehicle control information of the vehicle in which the wireless communication apparatus 106 is mounted.

On the other hand, the wireless communication apparatus 106 that is not scheduled to reach the join point 107 (for example, the wireless communication apparatus 106 mounted in the vehicle whose destination does not pass through the join point 107) can avoid unnecessary communication by not performing registration with respect to the topic. In an example, the vehicle 104 roughly travels toward the join point 107 but travels on a lane opposite to a lane including the join point 107. Therefore, the wireless communication apparatus 106 mounted in the vehicle 104 does not send a subscription registration request for the topic concerning the join point 107. As a result, the wireless communication apparatus 106 mounted in the vehicle 104 does not establish sidelink with the wireless communication apparatus 106 mounted in the vehicle 102 or 103, and can operate not to acquire information transmitted from the publisher.

Note that in this embodiment, the operations of the wireless communication apparatuses 106 mounted in the vehicles 102 to 104 will be described but the present invention is not limited to this. That is, the method according to this embodiment can be applied to any application for the wireless communication apparatus to exchange predetermined information with a partner apparatus in a cell of a wide range formed by one or more base stations and perform direct communication when moving close to the partner apparatus.

### (Arrangement of Apparatus)

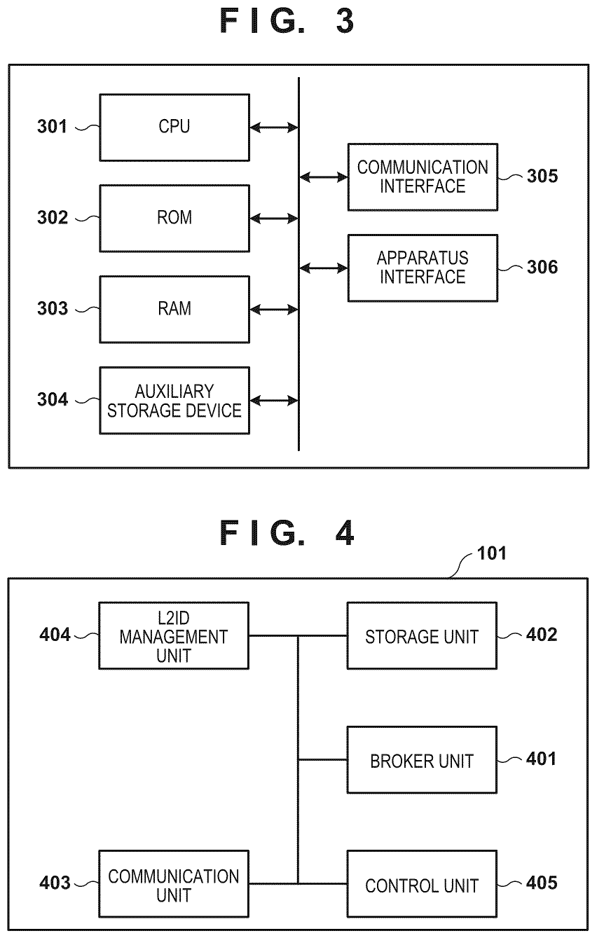

FIG. 3 shows an example of the hardware arrangement of the server 101 and the wireless communication apparatus 106. Each of the server 101 and the wireless communication apparatus 106 includes a CPU 301, a ROM 302, a RAM 303, an auxiliary storage device 304, a communication I/F 305, an apparatus I/F 306, and a bus 307. Note that CPU is an abbreviation for Central Processing Unit, ROM is an abbreviation for Read Only Memory, and RAM is an abbreviation for Random Access Memory. In addition, I/F is an abbreviation for interface.

The CPU 301 is a processor that controls the overall apparatus by, for example, executing a computer program stored in the ROM 302. The CPU 301 can be configured to execute processing to be described as processing executed by the server 101 or the wireless communication apparatus 106 in this embodiment by executing a computer program. Note that one CPU 301 is shown in FIG. 3 but a plurality of physically separated processors, a multicore processor, or the like may be used. Alternatively, another processor such as an MPU (Micro Processing Unit), an FPGA (Field Programmable Gate Array), a DSP (Digital Signal Processor), or an ASIC (Application Specific Integrated Circuit) may be used. That is, the CPU 301 is an example of one or more processors, and may be replaced by another processor or used in combination with another processor. In an example, by using the CPU 301 and an FPGA or DSP, it is possible to reduce the processing load of the CPU 301. The ROM 302 is a read only memory, and is configured to hold information that need not be changed, for example, a computer program for controlling the apparatus to be executed by the CPU 301. The RAM 303 can function as, for example, a work memory when the CPU 301 executes a computer program. The auxiliary storage device 304 is, for example, a storage device that stores a computer program to be executed by the apparatus and data to be used by the apparatus. For example, the information stored in the auxiliary storage device 304 can be loaded to the RAM 303, and processed by the CPU 301. The auxiliary storage device 304 can be formed by, for example, a hard disk drive (HDD), a solid state drive (SSD), or the like. Note that the ROM 302, the RAM 303, and the auxiliary storage device 304 are examples of a memory or a storage device, and at least one of one or more memories and one or more storage devices can be included in the apparatus.

The communication I/F 305 is an interface used for communication with an external apparatus. For example, the communication I/F 305 of the server 101 is configured to be able to communicate with the base station 105 (via, for example, one or more routers or the like), and is configured to communicate with the communication I/F 305 of the wireless communication apparatus 106 via the base station 105. Furthermore, the communication I/F 305 of the wireless communication apparatus 106 is configured to establish wireless connection to the base station 105 or the communication I/F 305 of another wireless communication apparatus 106 to perform wireless communication. Note that the communication I/F 305 of the wireless communication apparatus 106 is configured to be connectable to a core network of the cellular communication system via the base station 105. In addition, the communication I/F 305 of the wireless communication apparatus 106 is configured to be able to communicate with each apparatus (for example, the communication I/F 305 of the server 101) connected to a network such as the Internet outside the cellular communication system via the base station 105. Each apparatus can acquire information from an external apparatus via the communication I/F 305, and temporarily store the acquired information in, for example, the auxiliary storage device 304 or the RAM 303. The apparatus I/F 306 is an interface for connecting other various apparatuses. For example, a display device used by a server manager to confirm information to be managed by the server 101 and a keyboard and a pointing device used to operate the server 101 can be connected to the server 101 via the apparatus I/F 306. For example, an in-vehicle image capturing apparatus, sensor, or the like can be connected to the wireless communication apparatus 106 via the apparatus I/F 306.

FIG. 4 shows an example of the functional arrangement of the server 101. For example, the server 101 includes, as its functions, a broker unit 401, a storage unit 402, a communication unit 403, an L2ID management unit 404, and a control unit 405. These functions can be implemented when, for example, the CPU 301 executes computer programs held in the ROM 302 and the RAM 303. However, the present invention is not limited to this. For example, some or all of the above-described functions of the server 101 may be implemented using dedicated hardware components. Note that the functional blocks shown in FIG. 4 are merely examples. Some (all in some cases) of the functional blocks to be described may be replaced by other functional blocks that implement the same functions, some functional blocks may be omitted, and further functional blocks may be added. One functional block to be described below may be divided into a plurality of functional blocks, and a plurality of functional blocks may be integrated into one functional block.

The broker unit 401 mediates communication between a plurality of communication apparatuses (for example, the wireless communication apparatuses 106) respectively operating as a publisher and a subscriber in the publish/subscribe communication method. The storage unit 402 executes control to store various kinds of information. The communication unit 403 executes processing for performing communication with another apparatus existing outside the server 101. The L2ID management unit 404 manages an L2ID designated with respect to a communication apparatus outside the server 101, with which sidelink communication can be performed. Note that the L2ID management unit 404 may generate an L2ID and notify the external communication apparatus of it, or may cause the external communication apparatus to, for example, execute setting of sidelink communication with the base station to acquire an L2ID and make a notification of the L2ID. That is, the L2ID may be generated by the server 101 or, for example, a value generated in the cellular communication system may be sent as the L2ID. The control unit 405 controls the above-described functions of the server 101. For example, the control unit 405 executes processing for causing the respective functional units to cooperatively operate.

Upon receiving a subscription registration request from the communication apparatus outside the server 101, the broker unit 401 associates the identifier, IP address, and port number of the communication apparatus with a topic name designated by the subscription registration request. Note that IP is an abbreviation for Internet Protocol. The topic name is identification information associated with information to be distributed. The broker unit 401 stores the associated information in the storage unit 402. This registers the communication apparatus as a subscriber with respect to the designated topic name. In addition, upon receiving a publication distribution request from the communication apparatus operating as a publisher, the broker unit 401 generates a publication message to distribute, to the subscriber, a topic corresponding the publication distribution request. The broker unit 401 distributes, via the communication unit 403, the publication message to the communication apparatus registered as the subscriber with respect to the designated topic name.

After the broker unit 401 registers the topic, the L2ID management unit 404 acquires an L2ID necessary for sidelink communication, and stores the L2ID in the storage unit 402 in association with the topic name. The L2ID management unit 404 notifies the external communication apparatus operating as the publisher of the L2ID via the communication unit 403. Note that the L2ID management unit 404 may cause the external communication apparatus operating as the publisher to acquire the L2ID in the cellular communication system and to notify the server 101 of the L2ID. In this case, the L2ID management unit 404 can store the notified L2ID in the storage unit 402. The L2ID management unit 404 can distribute an L2ID stored in the storage unit 402 in association with a given topic to the communication apparatus registered as the subscriber with respect to the topic. Note that for example, only if the communication apparatus can execute communication using the L2ID such as sidelink communication, the L2ID management unit 404 manages the L2ID; otherwise the L2ID management unit 404 does not manage the L2ID. Note that if the direct communication method different from sidelink communication is used, a functional unit that manages parameters such as an identifier, modulation/demodulation information, an authentication method, and an encryption method, and an encryption key to be used for communication may be prepared instead of the L2ID management unit 404. Note that the L2ID management unit 404 may manage parameters to be used for sidelink communication, such as modulation/demodulation information, an authentication method, an encryption method, and an encryption key in addition to the L2ID, and generate these parameters, as needed.

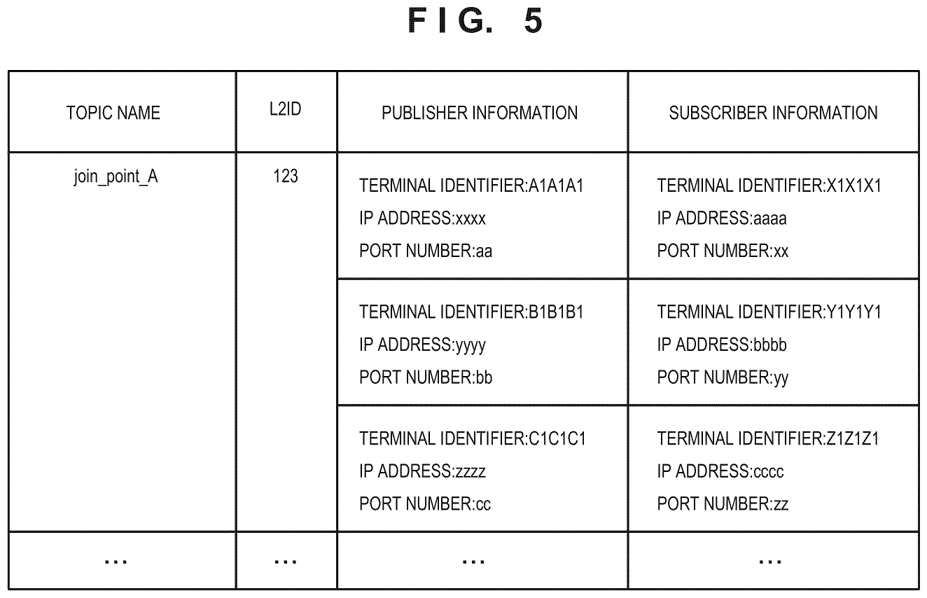

As described above, the storage unit 402 stores, in association with each other, the topic name and information such as the identifier, IP address, and port number of the communication apparatus operating as the publisher/subscriber, and also stores the L2ID. FIG. 5 shows an example of the stored information. As shown in FIG. 5, the storage unit 402 stores the L2ID, publisher information, and subscriber information in association with the topic name. Note that FIG. 5 shows an example in which three subscribers are associated with three publishers. However, the number of publishers and the number of subscribers need not be equal to each other, and for example, a plurality of subscribers may be associated with one publisher. Furthermore, all the communication apparatuses each operating as a publisher may be registered as subscribers, and all the communication apparatuses each registered as a subscriber may operate as publishers. That is, a plurality of communication apparatuses associated with the topic name may transmit/receive information. Furthermore, the stored information in FIG. 5 is merely an example. Other information may further be stored or part of the information shown in FIG. 5 may not be stored.

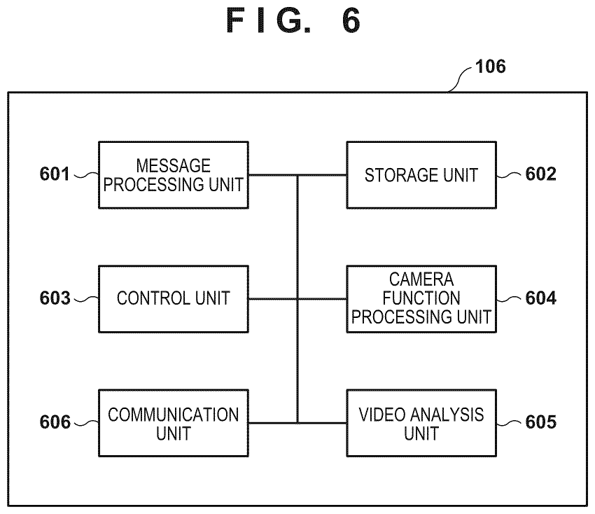

FIG. 6 shows an example of the functional arrangement of the wireless communication apparatus 106. For example, the wireless communication apparatus 106 includes, as its functions, a message processing unit 601, a storage unit 602, a control unit 603, a camera function processing unit 604, a communication unit 606, and a video analysis unit 605. These functions can be implemented when, for example, the CPU 301 executes computer programs held in the ROM 302 and the RAM 303. However, the present invention is not limited to this. For example, some or all of the above-described functions of the wireless communication apparatus 106 may be implemented using dedicated hardware components. Note that the functional blocks shown in FIG. 6 are merely examples. Some (all in some cases) of the functional blocks to be described may be replaced by other functional blocks that implement the same functions, some functional blocks may be omitted, and further functional blocks may be added. For example, the wireless communication apparatus 106 may have only a function associated with communication processing, and the camera function processing unit 604 and the video analysis unit 605 may be omitted. In addition, one functional block to be described below may be divided into a plurality of functional blocks, and a plurality of functional blocks may be integrated into one functional block.

The message processing unit 601 processes a message of the publish/subscribe communication method. For example, if the wireless communication apparatus 106 operates as a publisher, the message processing unit 601 generates a topic registration request message for publication distribution of a message including information such as an analysis result (road traffic information) of the video analysis unit 605. After the registration of the topic, the message processing unit 601 can generate a publication distribution request message to distribute the analysis result of the video analysis unit 605. Furthermore, the message processing unit 601 can generate a message for a deletion request of the topic to end the distribution of the information concerning the topic. Alternatively, if the wireless communication apparatus 106 operates as a subscriber, the message processing unit 601 can generate a message to receive the distribution of information distributed by another wireless communication apparatus 106, and cause the communication unit 606 to transmit the message. For example, the message processing unit 601 can generate a subscription registration message with respect to the topic, and a message to request release of the registration. The message processing unit 601 can supply these messages to the communication unit 606 to transmit them to the server 101. Furthermore, the message processing unit 601 can receive, via the communication unit 606, a message from an apparatus outside the wireless communication apparatus 106, such as a message concerning the registered topic.

The storage unit 602 stores various kinds of information such as topic information necessary for communication by the publish/subscribe communication method and an L2ID necessary for sidelink communication. The control unit 603 controls the overall wireless communication apparatus 106. For example, the control unit 603 is configured to control the functional units shown in FIG. 6 to execute such adjustment processing that the functional units cooperatively operate. If, for example, an image sensor such as a camera is mounted in the wireless communication apparatus 106, the camera function processing unit 604 executes processing of acquiring image information by image capturing using the image sensor, image processing for allowing the video analysis unit 605 to analyze the image information, and the like. In addition, for example, the camera function processing unit 604 can acquire image information obtained by image capturing from an external image sensor connected to the wireless communication apparatus 106, and execute image processing based on the image information. The video analysis unit 605 analyzes the image information obtained by the camera function processing unit 604 to perform detection of an object as a detection target by, for example, analyzing the status on a road such as an intersection. For example, the video analysis unit 605 detects an event that may influence the operation of the vehicle, such as the presence/absence of a traffic accident or congestion and the presence/absence of a vehicle such as an emergency vehicle, a construction work vehicle, or an abnormal moving vehicle. In an example, as described above, the detection result of the video analysis unit 605 can be included as road traffic information in a publication distribution request message by the message processing unit 601.

The communication unit 606 communicates with the server 101 via the base station 105 by establishing wireless connection to the base station 105 and performing wireless communication with the base station 105. Furthermore, the communication unit 606 communicates with another apparatus (for example, the wireless communication apparatus 106 mounted in another vehicle) by, for example, publish/subscribe communication. For example, the communication unit 606 transmits a message generated by the message processing unit 601 to the base station 105 by designating the address of the server 101 as destination information. In addition, the communication unit 606 can transmit the publication distribution request generated by the message processing unit 601 to the base station 105 by designating the address of the server 101 as destination information. This transfers these messages from the base station 105 to the server 101. The communication unit 606 can receive a message concerning the registered topic from the server 101 via the base station 105. The communication unit 606 can communicate with another apparatus (for example, the wireless communication apparatus 106 mounted in another vehicle) by sidelink communication without intervention of the base station 105. In an example, the communication unit 606 can directly transmit/receive information such as the above-described position information, traveling speed, and moving distance to/from the wireless communication apparatus 106 mounted in another vehicle by sidelink communication.

### (Procedure of Processing)

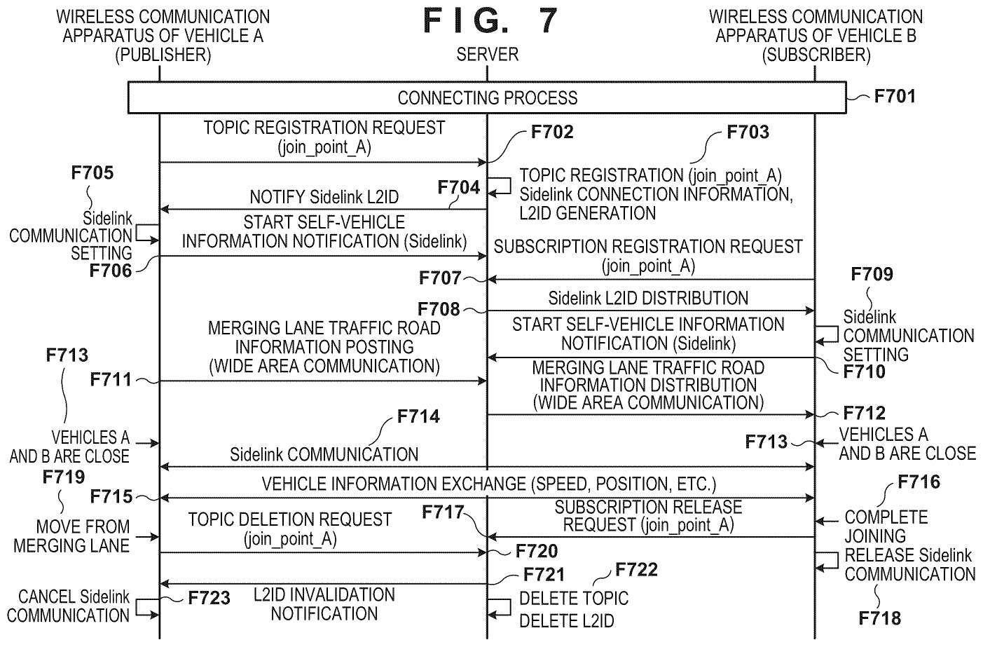

Subsequently, an example of the procedure of processing executed in this system will be described. FIG. 7 is a sequence chart showing an example of the procedure of communication in the system. In this example, assume that vehicle A (vehicle 102) and vehicle B (vehicle 103) are traveling toward the join point 107. Note that the wireless communication apparatus 106 mounted in the vehicle 102 will be referred to as the “vehicle 102” hereinafter. The same applies to the vehicles 103 and 104.

Assume that each of the vehicles 102 to 104 is configured to communicate with the server 101 during traveling, and execute communication by the publish/subscribe communication method. In FIG. 7, each of the vehicles 102 and 103 can be connected to the server 101 to execute publish/subscribe communication (F701). Note that publish/subscribe communication can be performed in accordance with a protocol such as MQTT (Message Queueing Telemetry Transport) or ROS (Robot Operating System). Note also that these are merely examples, and an arbitrary communication protocol such as another protocol can be used. The vehicles 102 to 104 can exchange information requiring no immediacy using publish/subscribe communication, for example, information of a congestion state on the periphery of each vehicle. If, for example, the vehicles 102 and 103 are close to each other and predict a status in which communication requiring immediacy is necessary, they perform sidelink communication. As an example, in this embodiment, a vehicle traveling on one of a merge lane and a traveling lane which the merge lane joins performs sidelink communication for control for appropriate merging. Note that this is merely an example, and a communication apparatus that is predicted to perform high immediacy communication can apply the following processing.

Note that in this embodiment, for example, the vehicle 104 travels on neither the merge lane nor the traveling lane which the merge lane joins. Therefore, the vehicle 104 need not perform high immediacy communication described here, and can thus be configured not to execute communication (to be described below) with the vehicle 102 or 103. However, the vehicle 104 can perform publish/subscribe communication to exchange general traffic information. Note that to exchange such general traffic information, each of the vehicles 102 to 104 can operate as a publisher for distributing information with respect to a predetermined topic, and also operate as a subscriber for receiving information of another vehicle.

Each of the vehicles 102 to 104 is configured to transmit/receive information of a topic concerning a join point by publish/subscribe communication in a case where, for example, the lane on which the vehicle is traveling joins another lane or another lane joins the lane on which the vehicle is traveling. For example, the vehicle (vehicle 102) whose traveling lane is joined with another lane transmits, to the server 101, a topic registration request that designates the topic name for publication distribution (F702). Note that the topic name can be provided from the system when, for example, publish/subscribe communication with the server 101 can be executed. Thus, for example, each of a plurality of vehicles traveling on the same lane as that of the vehicle 102 may operate as a publisher with respect to the same topic name. Note that in FIG. 7, “join_point_A” is designated as the topic name.

For example, the topic name can be preset as a name for designating the topic concerning the join point 107. In an example, the server 101 can preset information representing the topic name concerning the join point or the like included in a wireless communication area, and the vehicle can acquire at least part of the information when the vehicle is initially connected to the server 101. For example, when the vehicle is initially connected to the server 101, the vehicle can notify the server 101 of the position information of the self-vehicle, and the server 101 can notify the vehicle of information that associates the topic name with the position information of the join point or the like existing on the periphery of the position. Furthermore, the server 101 can estimate the position of the vehicle from the topic registration request received from the vehicle or a subscription registration request (to be described later), and successively notify the vehicle of the topic name of the join point or the like on the periphery of the vehicle. The vehicle may collectively acquire and hold information that associates the topic name with the join point or the like at the time of production or at the time of setting of a navigation system. Note that the join point is merely an example, and for example, a topic name associated with arbitrary traffic-related information such as an intersection, a branch, a point where there are many pedestrians and the like, or a slope can be defined in advance, and held in the vehicle. In addition, information (for example, tourist spot information, event information, and the like) other than the traffic-related information may be shared by publish/subscribe communication, and a topic name may be designated for such temporary information. Note that the topic name may be represented by a name that can be understood by a human user. This displays, for example, a topic name list in a vehicle as a subscriber candidate, thereby allowing the user to select a topic name and acquire information. The topic name may be represented by, for example, a name that is difficult for a human to discriminate as long as the name can be determined by the in-vehicle wireless communication apparatus 106. That is, in a case where a human is not involved in, for example, automated driving control of the vehicle, the topic name may be designated by any character string.

Upon receiving the topic registration request message in F702, the server 101 executes registration processing with respect to the topic name designated by the message (F703). At this time, the topic name “join_point_A” is designated. As shown in FIG. 5, the server 101 serves as a publisher for the topic name to register the information (terminal identifier, IP address, port number, and the like) of the wireless communication apparatus 106 of the vehicle 102. In addition, in case the vehicle 102 as the transmission source of the message executes sidelink communication with another vehicle, the server 101 generates a layer 2 identifier (L2ID) necessary for the communication (F703). Then, the server 101 notifies, of the generated L2ID, the vehicle 102 as the transmission source of the message (F704). Note that in a case where the topic “join_point_A” has already been registered in response to a request from another vehicle, the server 101 registers the vehicle 102 as a publisher for the topic instead of newly setting information concerning the topic. In addition, instead of newly generating an L2ID, the server 101 notifies the vehicle 102 of the L2ID already stored in association with the topic. Note that at the timing of generating an L2ID, the vehicle 102 may execute processing of, for example, generating a common encryption key usable for encryption and decryption of data in sidelink communication.

Upon receiving the L2ID from the server 101, the vehicle 102 performs setting for sidelink communication (F705). For example, the vehicle 102 sets to use the received L2ID as the transmission source identifier and the reception destination identifier of sidelink communication, thereby setting a state in which sidelink communication is possible. This allows the vehicle 102 to execute sidelink communication with another vehicle having the common L2ID. The vehicle 102 sets the received L2ID as the transmission source and the reception destination, and starts to make a notification of the position information, traveling speed, moving distance, and the like of the self-vehicle by sidelink communication (F706).

On the other hand, a vehicle (vehicle 103) whose traveling lane is joined with another lane transmits a subscription registration request message to the server 101 to receive distribution of information concerning the join point 107 (F707). At this time, the vehicle 103 transmits the subscription registration request message by designating the topic name “join_point_A” concerning the join point 107. Then, upon receiving the subscription registration request, the server 101 searches whether the topic concerning the designated topic information is registered. If it is confirmed that the topic “join_point_A” is registered, the server 101 distributes, to the vehicle 103, the L2ID stored in association with the topic name (F708). Then, upon receiving the L2ID distributed from the server 101, the vehicle 103 performs setting for sidelink communication (F709). This setting is the same as in F705. Upon completion of the setting, the vehicle 103 sets the received L2ID as the transmission source and the reception destination, and starts to make a notification of the position information, traveling speed, moving distance, and the like of the self-vehicle by sidelink communication (F710).

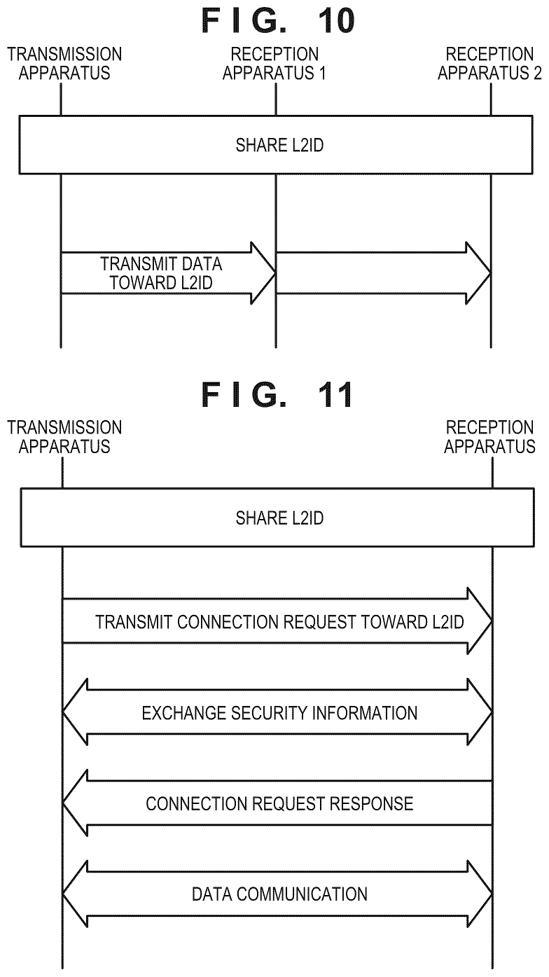

Sidelink communication will now be described. Sidelink communication includes “broadcast communication method”, “groupcast communication method”, and “unicast communication method”. If “broadcast communication method” or “groupcast communication method” is used, a radio frame including data in which the shared L2ID is set as the identifiers of a transmission source and a reception destination in a transmission-side apparatus is transmitted, as shown in FIG. 10. Then, if a reception-side apparatus receives a radio frame in which the identifiers of a transmission source and a reception destination match the shared L2ID, it extracts data from the radio frame. In this way, data communication is possible by sharing the L2ID. On the other hand, if “unicast communication” is used, a transmission-side apparatus transmits a connection request by setting the shared L2ID as a destination, as shown in FIG. 11. A reception-side apparatus that shares the L2ID responds to the connection request, and exchanges security information. When the reception-side apparatus transmits, to the transmission-side apparatus, a response to the connection request, these apparatuses can execute data communication. The method according to this embodiment is applicable even if any of the communication methods is used. However, assume here that “groupcast communication method” is used.

Note that the information notified in F706 or F710 is not received unless the wireless communication apparatuses 106 for which sidelink communication is set by the same L2ID move close to each other. In this status, the vehicle 102 distributes traffic road information based on an environment detected by the self-vehicle by publish/subscribe communication using, for example, wide area communication via the base station 105. That is, the vehicle 102 transmits a message including the information to the server 101 for publication distribution of the traffic road information (F711). Furthermore, the vehicle 103 can receive, from the server 101, the traffic road information distributed by the vehicle 102 by, for example, wide area communication via the base station 105 (F712).

After that, when the vehicles 102 and 103 travel toward the join point 107 to be close to each other (F713), each of the vehicles 102 and 103 can receive vehicle information sent by one another. When this state is set, the vehicles 102 and 103 perform sidelink communication (F714). Since it is estimated that each vehicle performs handle or brake control at a specific position like the join point 107, it may be required to exchange information between the vehicles with a low delay. Therefore, in this embodiment, when the vehicles 102 and 103 move close to each other around the join point 107, information such as the position information, traveling speed, and moving distance of each vehicle is transmitted/received by sidelink communication (F715). By transmitting/receiving the information, each vehicle can grasp not only the presence of another vehicle but also information such as the position information and speed information of the vehicle at the join point 107, thereby, for example, supporting driving of a driver. In addition, when information can be exchanged with a low delay, each vehicle can cope with merging order control, brake control in an emergency, and the like. Road traffic information about an accident, congestion, an emergency vehicle, a construction work vehicle, an abnormal moving vehicle, and the like, which is distributed by wide area communication, can also be transmitted with a low delay by sidelink communication.

After that, assume that joining of the vehicle 103 is completed (F716). In this case, the vehicle 103 need not acquire the information of the topic concerning the join point 107 anymore. Therefore, to cancel the reception of the information subjected to publication distribution, the vehicle 103 transmits a subscription release request message to the server 101 (F717). Then, the vehicle 103 deletes the L2ID associated with the topic concerning the join point 107, and performs stop processing of sidelink communication (F718). Note that the vehicle 103 can perform such processing not only at the time of completion of joining but also when, for example, the vehicle 103 does not pass through the join point 107 due to a route change. Note that if the vehicle 103 does not move close to the vehicle 102, the setting of the L2ID and the like are deleted without performing sidelink communication between the vehicles. In addition, when the vehicle 102 passes through the join point 107 after the completion of merging or when the vehicle 102 changes the lane from the merge lane (F719), the vehicle 102 need not distribute the information of the topic concerning the join point 107 anymore. In this case, the vehicle 102 transmits, to the server 101, a topic deletion request message that designates the topic name “join_point_A” of the topic concerning the join point 107 (F720).

This topic deletion request message is a request to delete the designated topic. On the other hand, in this embodiment, there can exit a plurality of publishers for the common topic, as described above. Therefore, if only the vehicle 102 is registered as a publisher for the topic, the server 101 deletes the topic, and if there exists another publisher for the topic, the server 101 deletes the information of the vehicle 102 from the publisher list. Then, regardless of whether to delete the topic, the server 101 transmits an L2ID invalidation notification to the vehicle 102 to cause the vehicle 102 to delete the L2ID (F721). If a publisher for the topic designated by the topic deletion request message disappears, the server 101 deletes the topic and the L2ID (F722). On the other hand, if there exists a publisher other than the vehicle 102 for the topic, the server 101 can maintain the topic and the L2ID.

Upon receiving the L2ID invalidation notification, the vehicle 102 deletes the L2ID, and ends sidelink communication using the L2ID (F723). Note that if the vehicle 102 has another L2ID associated with another topic, it can continue sidelink communication (notification information transmission) using the L2ID. That is, sidelink communication associated with the join point 107 may be prevented from being performed, and sidelink communication corresponding to an event associated with another point or traffic may be maintained. Note that in FIG. 7, the server 101 transmits the L2ID invalidation notification only to the vehicle 102, but the server 101 may transmit the L2ID invalidation notification to the vehicle 103 as a response to the subscription release request message. Without transmitting the L2ID invalidation notification to the vehicle 102 by the server 101, in response to transmission of the topic deletion request message, the vehicle 102 may delete the L2ID corresponding to the topic designated by the message, and its associated setting information.

In the above-described example, after the vehicle 103 transmits the subscription release request message, the vehicle 102 transmits the topic deletion request message. Thus, after the subscriber for the topic concerning the join point 107 disappears, the publisher disappears. To the contrary, the publisher can transmit the topic deletion request message first, and a publisher for a given topic can disappear before the subscriber. In this case, when the publisher disappears, the topic may be deleted, or only the subscriber may maintain the topic and the L2ID. For example, if there is no other vehicle on a lane on which the vehicle 102 is traveling, it is assumed not to distribute information to the vehicle 103 even if the vehicle 103 has performed subscription registration, and thus the topic and the L2ID may be deleted when the publisher disappears. On the other hand, by maintaining the topic and the L2ID, the vehicle 103 can receive distribution of information without performing subscription registration again when another vehicle moving close to the join point 107 is registered as a publisher.

Note that instead of the topic deletion request message and the subscription release request, another message for requesting to end the distribution of the information or the reception of the distributed information may be transmitted/received. In this case as well, the topic and the L2ID may be deleted when the publisher disappears or when the registered vehicles including the subscriber disappear.

### (Operation of Server)

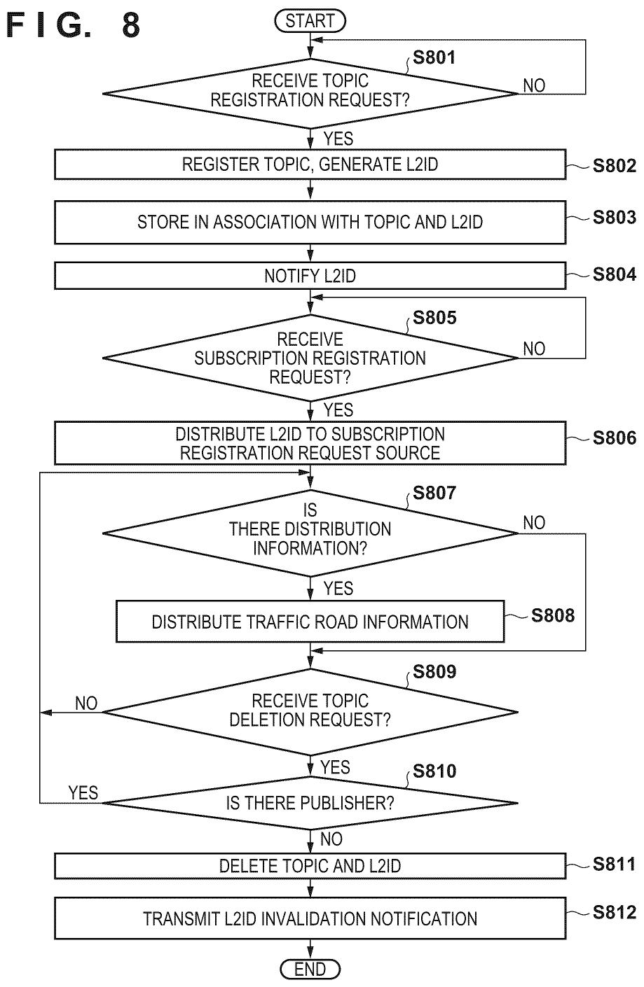

Subsequently, the operation of the server 101 will be described with reference to FIG. 8. Processing to be described below can be implemented when, for example, the CPU 301 of the server 101 executes a computer program stored in the ROM 302 or loaded from the auxiliary storage device 304 to the RAM 303. Note that this is merely an example, and part or all of the following processing may be implemented by dedicated hardware.

Upon receiving, by the broker unit 401, a topic registration request message from the wireless communication apparatus 106 via the communication unit 403 (YES in step S801), the server 101 performs registration processing with respect to a topic name designated by the message. The server 101 causes the L2ID management unit 404 to generate a layer 2 identifier (L2ID) necessary for communication in case the wireless communication apparatus 106 as the transmission source of the message executes sidelink communication (step S802). The server 101 causes the storage unit 402 to store the L2ID in association with the topic name designated by the message (step S803), and causes the communication unit 403 to notify, of the L2ID, the wireless communication apparatus 106 as the transmission source of the message (step S804).

On the other hand, the server 101 waits for a subscription registration request message from another vehicle (step S805). Upon receiving a subscription registration request message (YES in step S805), the server 101 confirms whether there exists an L2ID corresponding to the topic name designated by the message. If there exists the L2ID, the server 101 distributes the L2ID to the transmission source of the message (step S806). Thus, when a vehicle operating as a subscriber moves close to a vehicle operating as a publisher, these vehicles can perform sidelink communication without intervention of the base station 105.

If there exists a topic for which registration of a publisher and a subscriber is complete, the server 101 operates as a broker that mediates communication between the publisher and the subscriber. That is, the server 101 waits for registration of information to be distributed from the publisher (step S807). If the information is registered (YES in step S807), the server 101 distributes the information to the subscriber (step S808). Note that when the vehicle operating as the publisher moves close to the vehicle operating as the subscriber, sidelink communication is performed but the server 101 is not involved in the communication. After that, the server 101 repeats the processing of waiting for registration of information to be distributed and the processing of distributing the registered information until a topic deletion request message is received from the publisher (NO in step S809). Note that even if the server 101 receives a topic deletion request message from the publisher (YES in step S809), if another publisher for the topic is registered (YES in step S810), the server 101 does not delete the topic. That is, if the publisher disappears (NO in step S810), the server 101 deletes the topic (step S811). Note that when deleting the topic, the L2ID stored in association with the topic is also deleted. If the server 101 deletes the topic, it notifies the publisher as the transmission source of the topic deletion request message that the L2ID is invalid (step S812), and ends the processing.

Note that in the example shown in FIG. 8, after the L2ID is deleted, a notification that the L2ID is invalid is sent. However, the present invention is not limited to this. Even if the L2ID is not actually deleted, the server 101 can transmit, to the apparatus as the transmission source, an instruction to invalidate the L2ID of the transmission source of the topic deletion request message. If the server 101 receives a subscription release request message corresponding to a given topic, it may transmit a message for invalidating the L2ID to the apparatus as the transmission source of the message.

### (Operation of Wireless Communication Apparatus)

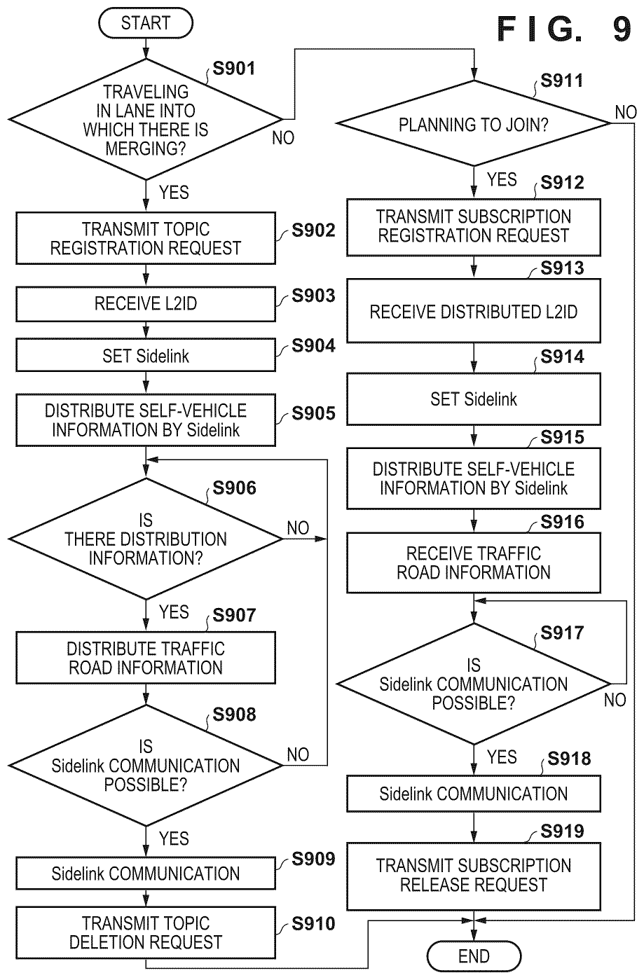

The operation of the wireless communication apparatus 106 mounted in each of the vehicles 102 to 104 will be described with reference to FIG. 9. Processing to be described below can be implemented when, for example, the CPU 301 of the wireless communication apparatus 106 executes a computer program stored in the ROM 302 or loaded from the auxiliary storage device 304 to the RAM 303. Note that this is merely an example, and part or all of the following processing may be implemented by dedicated hardware. Note that the wireless communication apparatus 106 mounted in the vehicle 102 will be referred to as the “vehicle 102” hereinafter, and the wireless communication apparatuses 106 mounted in the vehicles 103 and 104 will similarly be referred to as the “vehicle 103” and the “vehicle 104”, respectively, hereinafter unless specifically mentioned.

Each of the traveling vehicles 102 to 104 determines, based on the position information of the self-vehicle and map information of a car navigation system, whether there is possibility that the self-vehicle reaches a position joining another lane in the traveling direction. For example, each of the vehicles 102 to 104 determines whether there is another lane that may join a traveling lane on which the self-vehicle is traveling (step S901). If it is determined that there is no other lane that may join the traveling lane on which the self-vehicle is traveling (NO in step S901), each of the vehicles 102 to 104 determines whether there is possibility that the lane on which the self-vehicle is traveling joins another lane (step S911). Note that if each of the vehicles 102 to 104 determines that there is no other lane that may join the traveling lane on which the self-vehicle is traveling and there is no possibility that the lane on which the self-vehicle is traveling joins another lane (NO in steps S901 and S911), the processing ends. In the example shown in FIG. 1, since the vehicle 102 is traveling on the lane which another lane on which the vehicle 103 is traveling joins, the vehicle 102 determines that there is another lane that may join the traveling lane on which the self-vehicle is traveling (YES in step S901). The lane on which the vehicle 103 is traveling is a lane that joins the lane on which the vehicle 102 is traveling. Therefore, the vehicle 103 determines that there is no other lane that may join the traveling lane on which the self-vehicle is traveling, but there is possibility that the lane on which the self-vehicle is traveling joins another lane (NO in step S901 and YES in step S911). On the other hand, the lane on which the vehicle 104 is traveling does not join another lane, and is not joined with another lane. Therefore, the vehicle 104 determines that there is no other lane that may join the traveling lane on which the self-vehicle is traveling and there is no possibility that the lane on which the self-vehicle is traveling joins another lane (NO in steps S901 and S911), and the processing ends without performing further processes.

A description will be provided by paying attention to the vehicle 102. The vehicle 102 uses the message processing unit 601 and the communication unit 606 to transmit, to the server 101, a topic registration request message that designates a topic name for publication distribution (step S902). The information to be subjected to publication distribution is, for example, road traffic information about the presence/absence of an accident, congestion, an emergency vehicle, a construction work vehicle, an abnormal moving vehicle, and the like, which is generated by the camera function processing unit 604 and the video analysis unit 605.

If the vehicle 102 receives, from the server 101, the L2ID necessary to execute sidelink communication with another vehicle after transmitting the topic registration request message (step S903), the vehicle 102 performs setting for sidelink communication (step S904). Then, the vehicle 102 causes the communication unit 606 to include information such as the position information, traveling speed, and moving distance of the self-vehicle in a radio frame for sidelink communication for which the L2ID is set as a transmission source and a reception destination, and start to notify the periphery of the radio frame (step S905). On the other hand, although the setting for sidelink communication with another vehicle having the common L2ID is complete at this time, the vehicle 102 cannot perform sidelink communication unless it moves close to the other vehicle within a predetermined distance range. In this case, the vehicle 102 serves as a publisher in publish/subscribe communication to distribute information. That is, if the vehicle 102 causes the camera function processing unit 604 and the video analysis unit 605 to generate traffic road information to be distributed (YES in step S906), the vehicle 102 uses the communication unit 606 to perform publication distribution of the traffic road information to the server 101 (step S907). After that, in accordance with whether the vehicle 102 moves such close to another vehicle (for example, the vehicle 103) having the common L2ID that the vehicle 102 can receive notification information by sidelink communication from the other vehicle, the vehicle 102 determines whether it is possible to execute sidelink communication (step S908). If there exists another vehicle with which it is possible to execute sidelink communication (YES in step S908), the vehicle 102 executes sidelink communication with the other vehicle (step S909).

After that, when the vehicle 102 passes through the join point 107 after completion of merging or when the vehicle 102 is not involved in the join point 107 due to a lane change, the vehicle 102 need not distribute the information of the topic concerning the join point 107 anymore. In this case, the vehicle 102 can use the message processing unit 601 and the communication unit 606 to transmit a topic deletion request message to the server 101 with respect to the topic concerning the join point 107 (step S910). By transmitting this message, the vehicle 102 is not a publisher for the topic concerning the join point 107 anymore. Upon receiving an L2ID invalidation notification from the server 101 after transmitting this message, the vehicle 102 deletes the L2ID and the setting of sidelink communication using the L2ID. Note that in response to transmission of the topic deletion request message, the vehicle 102 may delete the L2ID and its associated setting corresponding to the topic name designated by the message.

Subsequently, a description will be provided by paying attention to the vehicle 103. Since the vehicle 103 is traveling on a lane that joins another lane (YES in step S911), the vehicle 103 causes the message processing unit 601 to transmit a subscription registration request message to the server 101 by designating the topic name corresponding to the join point 107 (step S912). Then, the vehicle 103 causes the communication unit 606 to receive a message including the L2ID corresponding to the designated topic name from the server 101 (step S913). Upon receiving the L2ID, the vehicle 103 performs setting for sidelink communication using the information (step S914). Then, the vehicle 103 causes the communication unit 606 to include information such as the position information, traveling speed, and moving distance of the self-vehicle in a radio frame for sidelink communication for which the L2ID is set as a transmission source and a reception destination, and start to notify the periphery of the radio frame (step S915). Note that the processes of steps S914 and S915 are the same as those of steps S904 and S905. Similar to the case of the vehicle 102, although the setting for sidelink communication with another vehicle having the common L2ID is complete at this time, the vehicle 103 cannot perform sidelink communication unless it moves close to the other vehicle within a predetermined distance range. Therefore, the vehicle 103 serves as a subscriber in publish/subscribe communication to receive information. That is, the vehicle 103 receives, from the server 101, the information concerning the topic for which the self-vehicle has performed subscription registration (step S916).

After that, in accordance with whether the vehicle 103 moves such close to another vehicle (for example, the vehicle 102) having the common L2ID that the vehicle 103 can receive notification information by sidelink communication from the other vehicle, the vehicle 103 determines whether it is possible to execute sidelink communication (step S917). If there exists another vehicle with which it is possible to execute sidelink communication (YES in step S917), the vehicle 103 executes sidelink communication with the other vehicle (step S918). After that, when merging is complete or when the vehicle 103 does not merge by changing a route before reaching the join point 107, configuration may be such that the vehicle 103 does not execute sidelink communication with the vehicle 102 at the join point 107. In this case, the vehicle 103 need not receive information distribution corresponding to the join point 107. Therefore, the vehicle 103 can use the message processing unit 601 and the communication unit 606 to transmit, to the server 101, a subscription release request message with respect to the topic concerning the join point 107 (step S919).

Then, the vehicle 103 ends the communication processing with respect to the join point 107 by transmitting the message. Note that the vehicle 103 can repeatedly execute the above-described processing, by the vehicle 103 or 102, of the subscription registration request and topic registration request of the corresponding topic in accordance with a traveling route, thereby appropriately transmitting/receiving information in accordance with the status of the self-vehicle.

Note that the example in which the vehicle 102 traveling on the lane which another lane joins operates as a publisher and the vehicle 103 traveling on the lane that joins another lane operates as a subscriber has been explained above. However, the present invention is not limited to this. For example, the vehicle 102 may operate as a subscriber and the vehicle 103 may operate as a publisher. Alternatively, both the vehicles 102 and 103 may operate as publishers and subscribers. That is, the vehicle 102 may receive the traffic road information of the vehicle 103, and the vehicle 103 may receive the traffic road information of the vehicle 102. In this case, the topic name of the topic for which the vehicle 102 operates as a publisher may be the same as or different from the topic name of the topic for which the vehicle 103 operates as a publisher.

In this embodiment, the vehicles 102 and 103 can exchange traffic road information by publish/subscribe communication with respect to the topic concerning the join point 107 before they move close to each other. Furthermore, since the vehicles 102 and 103 are traveling toward a common area (the join point 107), these vehicles are estimated to move close to each other. Therefore, the server 101 shares the L2ID for sidelink communication when these vehicles perform registration for publish/subscribe communication. Thus, it is possible to use sidelink communication in order for the vehicles to move close to each other and exchange control information requiring immediacy.

Note that distribution of the traffic road information by publish/subscribe communication is merely an example, and such information need not be distributed. For example, only distribution of the L2ID may be performed. In an example, the vehicle notifies a predetermined server of geographical ranges which the self-vehicle may pass through or may move close to during traveling among preset geographical ranges (for example, the above-described join point 107 and the like), and acquires information of an L2ID with respect to each geographical range. Then, when the vehicle moves close to another vehicle, it can perform sidelink communication based on the information of the L2ID. Instead of publication distribution of the information by the vehicle, the server may distribute general traffic road information and information based on image information acquired from a monitoring camera or the like. In this case, while receiving distribution of information of a traveling route or a scheduled traveling route, the vehicle can receive designation of the L2ID at the time of registration for the distribution of the information, thereby making it possible to perform sidelink communication with another vehicle to which the self-vehicle moves close. In this case, the wireless communication apparatus to be registered can be registered without discriminating between a publisher and a subscriber. Furthermore, sidelink communication is one form of direct communication, and direct communication of another form may be performed. In this case, the vehicle can be notified of another parameter instead of the above-described L2ID. That is, the server can register the wireless communication apparatus that is involved in information distribution (that distributes or receives information) in association with identification information (topic name) corresponding to the distributed information, and hold a parameter for direct communication such as an L2ID in association with the identification information. Then, the server provides the parameter associated with the identification information to the wireless communication apparatus registered in association with the identification information. This allows a plurality of wireless communication apparatuses associated with the same identification information to perform direct communication.

As described above, the above-described method can be used not only to associate direct communication with information distribution associated with traffic information but also for various applications. For example, with respect to the wireless communication apparatus that receives information distribution associated with a common hobby, the server registers the wireless communication apparatus in association with identification information concerning the distributed information. At this time, the server provides, to the wireless communication apparatus, the parameter for direct communication, which is associated with the identification information. Then, when the wireless communication apparatus moves close to another apparatus that receives the provided parameter, it can perform direct communication with the other apparatus. Thus, when users having a common hobby move close to each other, they can perform direct communication to exchange information.

According to the present invention, a wireless terminal can perform high immediacy communication with an appropriate partner apparatus.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An information processing apparatus comprising:
a registration unit configured to register a communication apparatus that has requested to distribute information and a communication apparatus that has requested to receive the distributed information in association with identification information for identifying a topic of the distribution;
a storage unit configured to store, in association with the identification information, a parameter for direct communication between a plurality of communication apparatuses; and
a providing unit configured to provide a first parameter stored in association with first identification information to a first communication apparatus that has requested to distribute information of a first topic corresponding to the first identification information and a second communication apparatus that has requested to receive the information of the first topic corresponding to the first identification information.

2. The information processing apparatus according to claim 1, wherein the registration unit sets, as the identification information, a topic name of information distributed by publish/subscribe communication, and registers, in association with the topic name, a communication apparatus operating as a publisher and a communication apparatus operating as a subscriber.

3. The information processing apparatus according to claim 1, wherein the direct communication is sidelink communication by 3rd Generation Partnership Project (3GPP), and the parameter is a layer 2 identifier (L2ID).

4. The information processing apparatus according to claim 1, wherein the parameter includes an encryption key.

5. The information processing apparatus according to claim 1, further comprising a generation unit configured to generate the parameter.

6. The information processing apparatus according to claim 1, wherein in a case where the communication apparatus registered in association with the identification information requests to end the distribution of the information associated with the identification information or the reception of the distributed information, the providing unit notifies the communication apparatus that the parameter associated with the identification information is invalid.

7. The information processing apparatus according to claim 1, wherein in a case where the communication apparatus registered in association with the identification information requests to end the distribution of the information associated with the identification information or the reception of the distributed information, the registration unit releases the registration of the communication apparatus.

8. The information processing apparatus according to claim 7, wherein
in a case where the communication apparatus registered in association with the identification information disappears by the release, the registration unit deletes the identification information, and
in a case where the identification information is deleted, the storage unit deletes the parameter stored in association with the identification information.

9. The information processing apparatus according to claim 7, wherein
the registration unit discriminately registers the communication apparatus that distributes information associated with the identification information and the communication apparatus that receives the distributed information,
in a case where the communication apparatus that distributes the information associated with the identification information disappears by the release, the registration unit deletes the identification information,
in a case where the identification information is deleted, the storage unit deletes the parameter stored in association with the identification information, and
the providing unit notifies the communication apparatus which receives the distribution of the information associated with the deleted identification information that the parameter is invalid.

10. A communication apparatus comprising:
a notification unit configured to notify an information processing apparatus of a request to distribute information or receive the distributed information and to register the communication apparatus in association with identification information for identifying a topic of the distribution;
a reception unit configured to receive a parameter, associated with the identification information, for direct communication with another apparatus as a response to the request; and
a communication unit configured to distribute or receive information of the topic corresponding to the identification information by performing, by using the parameter, direct communication with another communication apparatus that has been registered by the information processing apparatus in association with the identification information and has received the parameter.

11. The communication apparatus according to claim 10, wherein
the distribution of the information or the reception of the distributed information is performed by publish/subscribe communication, and
the identification information is a topic name of the information distributed by the publish/subscribe communication.

12. The communication apparatus according to claim 10, wherein the direct communication is sidelink communication by 3rd Generation Partnership Project (3GPP), and the parameter is a layer 2 identifier (L2ID).

13. The communication apparatus according to claim 10, wherein the parameter includes an encryption key.

14. The communication apparatus according to claim 10, wherein
the notification unit notifies the information processing apparatus of a request to end the distribution of the information associated with the identification information or the reception of the distributed information by the communication apparatus registered in association with the identification information, and
the communication unit is configured not to perform direct communication using the received parameter based on the notification of the end request.

15. The communication apparatus according to claim 14, wherein
the reception unit receives an invalidation notification of the parameter based on the end request, and
the communication unit is configured not to perform direct communication using the received parameter based on the reception of the invalidation notification.

16. A control method executed by an information processing apparatus, comprising:
registering a communication apparatus that has requested to distribute information and a communication apparatus that has requested to receive the distributed information in association with identification information for identifying a topic of the distribution;
storing, in association with the identification information, a parameter for direct communication between a plurality of communication apparatuses; and
providing a first parameter stored in association with first identification information to a first communication apparatus that has requested to distribute information of a first topic corresponding to the first identification information and a second communication apparatus that has requested to receive the information of the first topic corresponding to the first identification information.

17. A non-transitory computer-readable storage medium that stores a program for causing a computer included in an information processing apparatus to perform a control method, the control method comprising:
registering a communication apparatus that has requested to distribute information and a communication apparatus that has requested to receive the distributed information in association with identification information for identifying a topic of the distribution;
storing, in association with the identification information, a parameter for direct communication between a plurality of communication apparatuses; and
providing a first parameter stored in association with first identification information to a first communication apparatus that has requested to distribute information of a first topic corresponding to the first identification information and a second communication apparatus that has requested to receive the information of the first topic corresponding to the first identification information.
